(19) United States
(12) Patent Application Publication
(10) Pub. No.: US 2007/0115247 A1
(43) Pub. Date: May 24, 2007

(54) Programmable picture frame

(76) Inventors: Zhan Chen, Carrollton, TX (US); Jianping Jiang, Richardson, TX (US)

Correspondence Address: FISH & RICHARDSON, PC, P.O. BOX 1022, MINNEAPOLIS, MN, 55440-1022, US

(21) Appl. No.: 11/517,005

(22) Filed: Sep. 6, 2006

Related U.S. Application Data
(60) Provisional application No. 60/715,005, filed on Sep. 7, 2005.

(51) Int. Cl. G09G 3/36

(52) U.S. Cl. 345/102

(57) ABSTRACT

Picture frames and display devices that use a layer of a dichroic optical material placed between two transparent substrates to control an optical transmission at different locations across the layer by applying control voltages at the different locations to display digital images.

This application claims the benefit of U.S. Provisional Application No. 60/715,005 entitled “PROGRAMMABLE PICTURE FRAME” and filed on Sep. 7, 2005.

### BACKGROUND

This application relates to picture frames for displaying digital images.

Digital imaging devices such as digital cameras, digital camcorders and digital camera or video phones are becoming increasingly popular in business applications and amongst general consumers. Digital photos captured by these and other digital imaging devices can be presented or displayed on computer monitors, televisions, projector displays, or simply on photo prints such as photographic papers or other printing media. Some users prefer to display digital photos on computer monitors or other display devices as slide shows, preferably on large screens.

### SUMMARY

In one aspect, this application describes a digital picture frame that includes a color passive display and a back lighting unit. The color passive display includes a layer of a dichroic optical material which changes an optical transmission in response to a control voltage, and electrodes forming a 2-dimensional pixel array across the layer of the dichroic optical material to apply and control electrical control voltages at different pixel positions in the layer of the dichroic optical material. The back lighting unit is used to generate light illuminating a back side of the layer of the dichroic optical material. The color passive display transmits the light from the back lighting unit to produce an image in response to image signals applied to the electrodes.

In another aspect, this application describes a digital picture frame that includes a back lighting unit to produce illumination light, a back substrate coupled to the back lighting unit to receive the illumination light via transmission, a front substrate spaced from the back substrate which transmit the illumination light, and a layer of a dichroic optical material placed between the front and the back substrates. The dichroic optical material changes an optical transmission in response to a control voltage applied to the dichroic optical material. This frame also includes back electrodes formed on the back substrate, and front electrodes formed on the front substrates so that the back and the front electrodes form a 2-dimensional pixel array across the layer of the dichroic optical material to apply and control electrical control voltages at different pixel positions in the layer of the dichroic optical material to modulate transmission of the illumination light. A layer of color filters is provided in this frame to filter the modulated transmission of the illumination light through the layer of the dichroic optical material to render colors. This frame also includes a driving unit electrically coupled to the front and the back electrodes to apply picture signals to the layer of the dichroic optical material to modulate the transmission of the illumination light through the layer of the dichroic optical material to display images.

In yet another aspect, this application describes a method for providing a large format digital display picture frame. This method uses a layer of a dichroic optical material placed between two transparent substrates to control an optical transmission at different locations across the layer by applying control voltages at the different locations to display digital images.

Particular embodiments of the invention can be implemented to realize one or more of advantages. For example, large format picture frames can be constructed using a dichroic optical material at a relatively low cost and suitable for mass production. For another example, such a large format picture frame can have a lower weight and consume less electrical power than other displays with similar sizes.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a part of a picture frame having a dichroic liquid crystal layer as a light switch material to obstruct the transmitting light in one state and to transmit the light in another state depending on an applied control voltage.

FIG. 2 shows a schematic of an exemplary driving unit that drives the dichroic liquid crystal layer in FIG. 1.

FIG. 3 shows an example of a back lighting system for the picture frame in FIG. 1.

### DETAILED DESCRIPTION

This application describes techniques and display devices for displaying digital photos and other digital images on large flat screens. In some implementations, the display devices described in this application may be full colored, programmable, versatile, affordable large digital display screens which can be hung on the wall as a digital picture frame for home and office enjoyment. The display devices may be configured to include a dichroic display unit to display images, a memory unit to store digital data of the images, and a backlighting unit to illuminate the dichroic display unit. A control circuit may be included in the display devices to control the image to be displayed, e.g., automatically changing the displaying picture according to a pre-programmed list of images or photos stored in the memory unit. The display devices may be configured to be compatible with other digital storage devices and computers for convenient transfer of digital photos, images and slides. The backlighting unit enhances the brightness of the displayed images and may be viewed in either well-lit or dark environments. Such display devices may be used to provide digital picture quality art in a big size display system and hang on wall as a picture frame.

Notably, the present display devices may be designed to provide large format displays in thin and flat-panel configurations at low cost in comparison to other large format displays in thin and flat-panel configurations. Many flat panel displays are designed and targeted for movie and TV display applications such as STN (super twist-nematic) displays, TFT (thin film transistor) displays, projector displays (e.g., LCOS, DLP) and direct view display systems such as plasmon display and LED displays. These and other large displays can be too expensive for use as wall-hanging picture frame display systems.

In some implementations, picture frames described here can be configured to provide a cost efficient solution to large format picture frames. For example, a dichroic imaging display unit can be used to produce the images for a picture frame and can change a displaying photo or image according to a preprogrammed setting. Digital picture or image files can be stored inside a digital memory unit for the display unit and can be replaced by downloading new images from digital photo devices, a computer or other digital file sources such as storage devices or an on-line server. A bright back-lighting module can be included in the display unit. The power supply for the system may be an AC power source, a DC power source, a battery power source, or a combination of at least.two of these power sources.

The present picture frames can be designed to support different image resolutions. For example, a high resolution at 1920×1240 pixels may be supported. A passive driving method may be used for the pixel driving to change the operating state of each pixel for display a pixel image. A dichroic liquid crystal can be used as the light switching material to produce the images. Three color filter matrixes may be used to generate colors for displayed images.

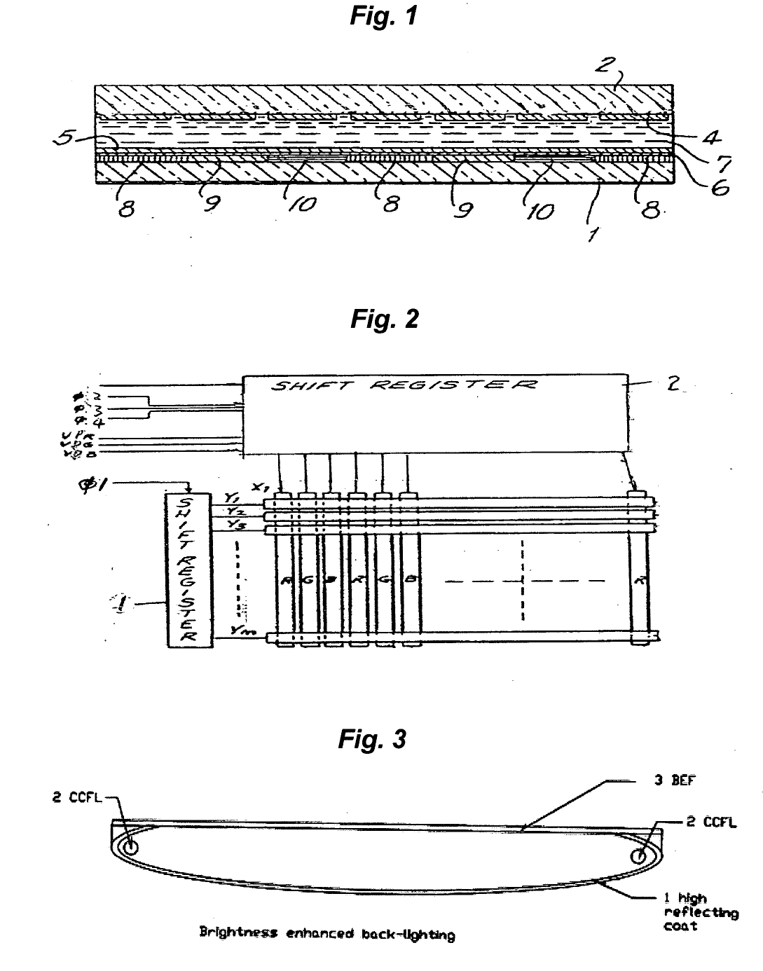

FIG. 1 illustrates an exemplary structure in accordance with one implementation of the present picture frames. This example includes a front glass substrate 1 through which an image is displaced to a viewer and a back glass substrate 2 which is engaged to a back lighting system to receive light for illuminating the frame. Other transparent substrates made of non-glass materials may also be used for the substrates 1 and 2, e.g., plastic materials. Three colored color filters 8, 9, 10 respectively for red, green and blue color filters are formed on the front glass substrate 1 to produce colored images to the viewer. A passivation layer 6 can be added to level the filter coating. Transparent horizontal electrode strips 5 are deposited on layer 6 as liquid crystal driving electrodes. On the back glass substrate 2, etched transparent vertical electrode strips 4 are formed. A dichroic liquid crystal layer 7 is sandwiched between the front and back substrates 1 and 2 and acts as a light switch material to obstruct the transmitting light in one state and to transmit the light in another state depending on the applied control voltage. The layer 7 can be made of a dichroic or dichroic mixture material film which exhibits a low absorption when the light passes through in a direction perpendicular to the elongated molecular axis of the material, and a high absorption when the light propagates along the molecule's long axis direction. A lower absorption state can be switched to a high absorption state by applying an electric field or vice versa. The response speed of the dichroic or dichroic mixture material is fast and usually less than 0.1 second. For example, the layer 7 can be made of a dichroic material under a trade name “ZLI-4727” manufactured and marketed by Merk.

FIG. 2 shows one example of a driving unit for the picture frame shown in FIG. 1. Shift register 1 selects driving electrodes Y1 through Ym successively in synchronization with a clock signal φ1. For each selected Y line, three color picture signals PSR, PSG and PSB for three color channels red, green and blue, respectively, are selected in synchronization with respective X clock signals φ2, φ3 and φ4. Shift register 2 distributes the display signal to every pixel and turns on or off the driving voltage on the dichroic liquid crystal. The color signals PSR, PSG and PSB are selected successively in synchronization with X clock signals and transmitted to X driving lines.

The above picture frames may be designed to reduce the verall cost of the frames, and to allow for mass production of large size wall hanging flat picture displays which provide a sufficient level of grey scales and true color display. The control built in such a picture frame may be designed to provide an automatic means for changing displayed images and with a fixed or varying display durations according a pre-set schedule programmed by a user and stored in the on-board memory unit.

Therefore, a wall hanging programmable picture display can be constructed based on the above designs to include a color passive driving dichroic matrix display as a display unit and backlighting unit behind the display unit. The display may include an on-board memory unit which stores the downloaded picture files with an interface connected to a digital file source such as a computer, a digital photo device, or a server connected via a network connection. The display may include on-board programmable unit which is programmed with one or more picture display schedules to automatically change displayed images.

Various back lighting systems may be used to provide desired illumination to the back of a picture frame described above.

FIG. 3 shows one exemplary back lighting system. This system uses a high reflection coating 1 formed on a reflector surface of the light chamber and a brightness enhanced film (BEF) 3 in the front of the back lighting system. The brightness enhanced film is designed with a structure that efficiently transmits to enhance the brightness of the display. In this particular example, two Cold Cathode Fluorescent Light tubes (CCFLs) 2 are used as the light source to produce white light and are placed inside the light chamber formed by the reflector surface with the high reflection coating 1 and the flat surface with the BEF 3. This back lighting design can be used as a bright un-polarized lighting source. When used with the picture frame in FIG. 1, the BEF side of the back lighting system is placed against the back glass substrate of the picture frame in FIG. 1 to illuminate the dichroic liquid crystal layer 7. The optical transmission of the dichroic liquid crystal layer 7 is modulated with images and is filtered by the filters 8, 9 and 10 to produce colored images through the front glass substrate 1.

While this specification contains many specifics, these should not be construed as limitations on the scope of any invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments have been described. Other embodiments are within the scope of the following claims.

What is claimed is:

1. A digital picture frame, comprising:
a color passive display comprising a layer of a dichroic optical material which changes an optical transmission in response to a control voltage, and electrodes forming a 2-dimensional pixel array across the layer of the dichroic optical material to apply and control electrical control voltages at different pixel positions in the layer of the dichroic optical material; and
a back lighting unit to generate light illuminating a back side of the layer of the dichroic optical material, wherein the color passive display transmits the light from the back lighting unit to produce an image in response to image signals applied to the electrodes.

2. The picture frame as in claim 1, further comprising a memory unit which stores digital images to be displayed on the color passive display.

3. The picture frame as in claim 2, wherein the memory unit comprises an interface which connects to a digital device to receive digital images to be stored in the memory unit.

4. The picture frame as in claim 1, further comprising a programmable unit that controls images displayed on the color passive display, wherein the programmable unit operates to change displayed images according to a pre-set display schedule.

5. The picture frame as in claim 1, further comprising color filters to filter light from the backlighting unit to render colors in the displayed image.

6. The picture frame as in claim 1, wherein the back lighting unit comprises a light source to produce white light, a reflector surface to reflect the white light towards the color passive display, and a brightness enhanced film as an interface between the back lighting unit and the color passive display to transmits the white light to the color passive display.

7. A digital picture frame, comprising:
a back lighting unit to produce illumination light;
a back substrate coupled to the back lighting unit to receive the illumination light via transmission;
a front substrate spaced from the back substrate which transmit the illumination light;
a layer of a dichroic optical material placed between the front and the back substrates, the dichroic optical material changing an optical transmission in response to a control voltage applied to the dichroic optical material;
back electrodes formed on the back substrate;
front electrodes formed on the front substrates, wherein the back and the front electrodes form a 2-dimensional pixel array across the layer of the dichroic optical material to apply and control electrical control voltages at different pixel positions in the layer of the dichroic optical material to modulate transmission of the illumination light;
a layer of color filters to filter the modulated transmission of the illumination light through the layer of the dichroic optical material to render colors; and
a driving unit electrically coupled to the front and the back electrodes to apply picture signals to the layer of the dichroic optical material to modulate the transmission of the illumination light through the layer of the dichroic optical material to display images.

8. The picture frame as in claim 7, wherein the driving unit comprises a memory unit which stores digital images to be displayed.

9. The picture frame as in claim 8, wherein the driving unit comprises an interface which is operable to connect to a digital device to receive digital images to be stored in the memory unit.

10. The picture frame as in claim 7, wherein the driving unit operates to change displayed images according to a pre-set display schedule.

11. A method for providing a large format digital display picture frame, comprising:
using a layer of a dichroic optical material placed between two transparent substrates to control an optical transmission at different locations across the layer by applying control voltages at the different locations to display digital images.
